(19) United States
(12) Patent Application Publication
(10) Pub. No.: US 2006/0222212 A1
(43) Pub. Date: Oct. 5, 2006

(54) One-dimensional iris signature generation system and method

(76) Inventors: Yingzi Du, Annapolis, MD (US); Robert Ives, Arnold, MD (US); Delores Etter, Edgewater, MD (US); Thad Welch, Annapolis, MD (US)

Correspondence Address: Naval Research Laboratory;Code 1008.2, 4555 Overlook Avenue, SW, Washington, DC, 20375-5325, US

(21) Appl. No.: 11/099,781

(22) Filed: Apr. 5, 2005

(51) Int. Cl. G06K 9/00

(52) U.S. Cl. 382/115

(57) ABSTRACT

An iris recognition system and method generates a one-dimensional iris signature that is translation, rotation, illumination and scale invariant. It allows users to enroll poor quality iris images that would be rejected by conventional methods. In addition, the system and method generates a list of possible matches instead of only the best match. In this way, the users could potentially identify the iris image by deeper analysis (such as using traditional iris recognition algorithm for more accurate iris identification). Further, the system and method permits more toleration of noise (such as glare introduced by contact lens or eye glasses). Finally, the system and method improves iris identification process computational efficiency. The system stores a one-dimensional signature as opposed to the conventional two-dimensional image.

### BACKGROUND

Biometrics, in general, uses unique and measurable physical, biological, or behavioral characteristics to establish identification, and to perform identity verification or automated recognition of a person. The three tasks of biometrics are: 1) verifying: “Are you who you say you are?”; 2) identifying: “You are in my database, can I find you?”; and 3) watchlisting: “Are you in my database? If so, who are you?”. Within these three tasks, identifying (one-to-many matches) is more difficult than verifying (one-to-one match), while watchlisting (few-to-many matches) would be the most difficult.

“Watchlisting” refers to the act of scrutinizing individuals to determine if they belong to a selected group, such as criminals. Watchlisting for alleged terrorists or terrorist associates has been pushed to the forefront of national security, at least, within the United States. Watchlisting is the most difficult biometric task because subjects generally are noncooperative or actively try to spoof the system.

The most publicized biometric characteristics, e.g., fingerprint, blood type, DNA, retina and iris, are typically used to identify or verify the identity of a single person. It has conventionally been the goal of the biometric system to obtain a one-to-one match thereby removing doubt of the identity of the person. As databases increase in size and as the accuracy in identification (or verification) approaches 100%, the complexity and computational power requirements of conventional biometric systems increase dramatically.

As mentioned above, fingerprints are one type of biometric characteristic typically used to identify or verify the identity of a single person. For example, a fingerprint located at a crime scene may be compared to a database of fingerprints to identify the owner of the crime scene fingerprint. In such instances, the crime scene fingerprint is recorded without knowledge of the owner of the fingerprint. Accordingly, cooperation of the owner in such instances is not an issue. In another example, a fingerprint from an individual may be compared with a previously stored fingerprint of that individual to verify the identity of the individual. In this case, typically, cooperation of the individual is required. However, either in the case of identifying the owner of a fingerprint or verifying the identity of a person via his fingerprint, when matching previously recorded fingerprints to a subject fingerprint (a fingerprint provided to determine a match), there are times when the fingers of the person may be worn to a point where obtaining a subject fingerprint is not possible and matching is not feasible.

Compared with fingerprints, iris and retina patterns are stable throughout life (they do not wear down) and are therefore more reliable than fingerprints for use in biometrics. This realization has led to the development of iris (and retina) recognition systems. Obviously an image of a person's iris (or retina) will typically not be found in a crime scene as in the case of fingerprints. On the contrary, conventionally, an image of a person's iris (or retina) is recorded with the cooperation of the owner. In this regard, conventional iris (or retina) recognition systems are generally used to verify the identity of a single person. For example, a person identifying himself as Mr. John Doe may permit imaging of his iris (or retina) for comparison with a previously stored image of Mr. John Doe's iris (or retina) to verify his identity.

A conventional iris (or retina) recognition system includes an imaging portion, a processing portion and a storage portion. A plurality of irises (or retinas) are individually imaged into two-dimensional images by the imaging portion. The processing portion processes each two-dimensional image and stores the processed data in the storage portion as a two-dimensional signature. An example of such a conventional method is disclosed in “High Confidence Visual Recognition of Persons by a Test of Statistical Independence,” by J. Daugman. The storage portion may further store identification information for each two-dimensional signature, wherein the identification information is associated with a corresponding person.

When a person is subsequently subjected to identity verification with the conventional iris (or retina) recognition system, the person's iris (or retina) is imaged to generate a subject two-dimensional signature. Each portion of the subject two-dimensional signature is then compared with each corresponding portion of each of the previously stored two-dimensional signatures from the storage portion, until a match is determined. If the subject two-dimensional signature matches a previously stored two-dimensional signature, then the identity of the person is verified via the stored identification information associated with the matched previously stored two-dimensional signature.

In order to increase the accuracy of the conventional iris (or retina) verification system, the translation, rotation, illumination and scaling attributes of the entire subject iris (or retina) image should be the same as those corresponding to the previously stored iris (or retina) signature. If they are not the same, then additional processing is required to compensate for the differences. For example, as discussed in both Daugman, id, and “A Human Identification Technique Using Images of the Iris and Wavelet Transform,” by Boles et al., to eliminate the effect of eye tilt, circular rotation of the iris pattern is usually necessary in iris matching and identification algorithms. In this regard, conventional iris (or retina) recognition systems require a full image of the entire iris (or retina) to create a signature. As such, to create a signature with conventional iris recognition systems, a person must be cooperative such that the eyelids are open wide enough to permit imaging of the entire iris.

What is needed is a system for recognizing a stable biometric characteristic of a person that does not require the cooperation of the person.

What is additionally needed is a system for recognizing an iris that does not require an entire image of the iris.

What is additionally needed is a system for recognizing an iris that translation and scale invariant, i.e., does not rely on the rotation or size of the iris.

What is additionally needed is a biometrically based system for creating a watchlist, wherein the system is less complex and uses much less computational power as compared to conventional biometric systems.

### BRIEF SUMMARY

It is an object of the present invention to overcome the problems associated with conventional biometric systems.

It is another object of the present invention to provide a system and method that fulfills the needs discussed above.

In accordance with an aspect of the present invention, measurable characteristics are used to generate a one-dimensional signature of an item. The generated one-dimensional signature may then be used for recognition purposes via a comparison with a library of previously stored signatures. For example, measurable defining characteristics such as color, patterning, size, shape, nuclear resonance, electromagnetic reflectivity and electromagnetic absorption (non-limiting examples of which include infrared reflectivity, infrared absorption, near infrared reflectivity, infrared absorption, x-ray reflectivity, x-ray absorption, multispectral reflectivity, multispectral absorption, hyperspectral reflectivity and hyperspectral absorption) may be used to generate a signature of an item, non-limiting examples of which include body characteristics (fingerprint, iris, retina, tissue, blood vessel layout, blood type, fluid or discharge sample content, etc.), cartographic images, compositions of matter and inanimate objects. In an exemplary embodiment, gray scale invariant local texture patterns (LTP) of an iris are used to generate a one-dimensional signature for the iris image, and an information divergence-based Du measurement is used to measure the similarity between a subject iris signature and iris signatures in a database. In accordance with this aspect of the present invention, only a one-dimensional signature is used, and no circular rotation is required in the matching process. Accordingly, the present invention improves iris identification computational efficiency.

The present invention is not limited to using a texture patterns as a characteristic to generate a one-dimensional signature of an iris image. On the contrary, as discussed above, any defining characteristic, such as color, reflectivity, etc., may be used so long as the characteristic distinguishes one iris from another. Similarly, the present invention is not limited to using a Du measurement to measure the similarity of iris signatures in a database. Any measurement scheme may be used to assign a ranking of similarity between an input iris signature and a plurality of stored iris signatures.

Further, in contrast to conventional iris recognition methods, which provide a single match, the present invention compares the input iris image to all iris patterns in the database and lists a predetermined number n of the stored iris patterns in order of similarity. In other words, the present invention generates a predetermined top number n possible matches for identification or verification purposes. This aspect of the present invention is particularly useful in decreasing computational time and power of conventional biometric recognition systems, as exemplified below.

Specifically, as discussed above, it has conventionally been the goal of biometric systems to obtain a one-to-one match thereby removing doubt of the identity of the person. Such a goal drives up the computational requirements of the systems. For example, it may take a large amount of computation power and time to determine the identity of Mr. Joe Terrorist with an accuracy of 95%. Alternatively for example, in accordance with the present invention, a person may be identified as one of the group consisting of the top three matches including Mr. Terrorist, the President of the Unites States and the Pope. Accordingly, the present invention may permit identification of a person in conjunction with extraneous data (in this example, the extraneous data is the presumed fact that the person does not look like, and therefore is not, either one of the President of the United States and the Pope) thereby saving computational power and time as compared with conventional biometric systems.

Still further, the present invention is not limited to iris imaging. On the contrary, as discussed above, other aspects such as any aspect that may be imaged, such as retinas, fingerprints, etc, may be used so long as the aspect distinguishes one object from another.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. It is noted that the exemplary embodiment is drawn to iris recognition. However novel aspects of the present invention are not limited in this scope. On the contrary, the novel aspects of the present invention can additionally be drawn to retina recognition or recognition of any parameter that can be imaged. In the drawings:

FIG. 1 illustrates an iris recognition system architecture in accordance with an exemplary embodiment of the present invention;

FIG. 2 illustrates an original image of an eye;

FIG. 3 illustrates a modified image of the eye as illustrated in FIG. 2 that is used to determine boundaries of an iris in accordance with an exemplary embodiment of the present invention;

FIG. 4 illustrates iris image, in polar coordinates, of the eye as illustrated in FIG. 2 in accordance with an exemplary embodiment of the present invention;

FIG. 5 illustrates the inner and outer boundary detection of the iris of the eye as illustrated in FIG. 2 in accordance with an exemplary embodiment of the present invention;

FIG. 6(a) illustrates a resolution invariant iris mask for use with the iris image of FIG. 5;

FIG. 6(b) illustrates the iris patterns after application of the resolution invariant iris mask of FIG. 6(a);

FIGS. 7-9 are illustrate pixel windows in accordance with an exemplary embodiment of the present invention;

FIG. 10 is a one-dimensional signature of the iris of FIG. 5;

FIGS. 11(a)-11(h) illustrate eight different irises and their corresponding signatures;

FIG. 12 illustrates enrollment of an iris signature in accordance with an exemplary embodiment of the present invention;

FIGS. 13(a)-13(c) illustrate three different images of a single eye;

FIG. 14 illustrates enrollment of an iris signature of the eye of FIGS. 13(a)-13(c); and

FIG. 15 is a magnified image of FIG. 13(a).

### DETAILED DESCRIPTION

A major problem in conventional recognition systems that analyze iris patterns is that the iris patterns are often not uniform due to variations in orientation, scale, contrast, or illumination. The present invention solves the problem of orientation variations of an iris by generating a one-dimensional signature. Further, the present invention solves the problem of scale variations of an iris by generating a mask. Still further, the present invention solves the problem of illumination variations of an iris by using a gray scale invariant Local Texture Patterns (LTP). Finally, the present invention solves the problem of contrast variations of an iris by using Du measurements. It should be noted that the present invention can be applied to non-iris imagery for texture analysis as well.

FIG. 1 illustrates an iris recognition system 100 in accordance with an exemplary embodiment of the present invention. In FIG. 1, system 100 includes an iris image input portion 102, a preprocessing portion 104, a mask generation portion 106, a local texture pattern (LTP) portion 108, an iris signature generation portion 110, an enrollment portion 112, an iris identification portion 114, an iris signature database portion 116 and an output portion 118.

Input portion 102 may comprise any input device that is operable to acquire data relating to a feature, in this case, to retrieve an image of the prescribed parameter (in this exemplary embodiment, an iris) and to transform the retrieved image into data that is usable by the preprocessing portion 104. Non-limiting examples of input portion 102 include a CCD or camera. Output portion 118 may comprise any output device that is operable to transform data from iris identification portion 114 into an audio and/or video signal to be recognized and understood by a user. Non-limiting examples of output portion 118 include, a video screen, speaker or combination thereof. Iris signature database portion 116 may comprise any database structure that is operable to store a plurality of data structures. Non-limiting examples of iris signature database portion 116 include a real or virtual hard drive. The structure of the remainder of the portions of system 100 may comprise hardware, software or a combination thereof that is operable to function in the respective manners as discussed in more detail below.

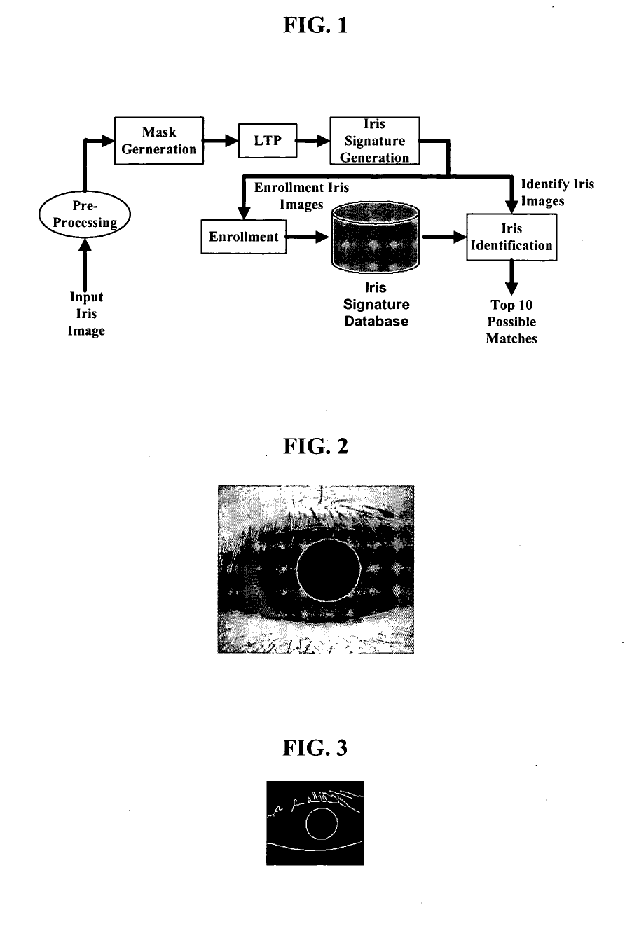

FIG. 2 illustrates an original image of an eye as captured by input portion 102. The eye includes a pupil 202, an iris 204 having a pupil boundary 206 and a limbic boundary 208, an upper eyelid 210, eye lashes 212 and a lower eyelid 214. Input portion 102 provides data corresponding to the original image of the eye to preprocessing portion 104.

Preprocessing portion 104 uses the data corresponding to the image of the eye from input portion 102 and locates the various components of the eye, such as pupil boundary 206, limbic boundary 208, an upper eyelid 210, eye lashes 212 and a lower eyelid 214 to determine the location of iris 204, as discussed below.

As an optional preprocessing step, preprocessing portion 104 may reduce the amount of data to shrink the original image to one quarter of the original size to speed up processing. Preprocessing portion 104 performs edge detection, for example via the Canny method, to the shrunken image, wherein each data point of the image is compared to a threshold value. FIG. 3 illustrates a modified image of the eye after such thresholding, wherein a circle 303, upper eyelid 210, eyelashes 212 and lower eyelid 214 are evident. Specifically, preprocessing portion 104 may then use parameters (center (x₀, y₀) and radius r₀) of circle 303 to estimate and optimize pupil boundary 206.

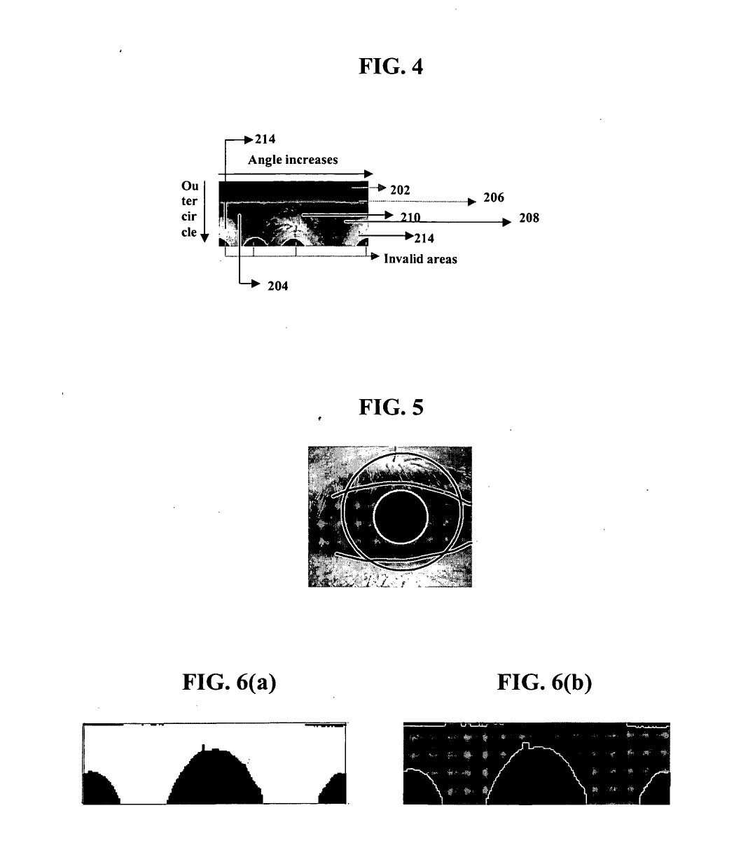

In this exemplary embodiment, the entire image is then transformed to polar coordinates with center (x₀, y₀), as illustrated in FIG. 4. On the polar axis, limbic boundary 208 is very nearly horizontal. The horizontal edges may be detected with any known method, such as for example via a horizontal Sobel filter. The longest horizontal edge after pupil boundary 206 is limbic boundary 208.

To remove the effects of eyelashes or high reflectance pixels (glare), a determination is made if any pixel value in the image is an outlier. To do this, variance of the grayscale intensities are computed in a window about each location of the image of the eye. If the computed variance is above a predetermined threshold, the pixel at that location can be reasonably discarded.

FIG. 5 illustrates the inner and outer boundary detection of the iris 204 of the eye as illustrated in FIG. 2 in accordance with an exemplary embodiment of the present invention. Accordingly, and as described in more detail below, the present invention enables iris recognition by using only a portion of the iris. This aspect of the invention is particularly important with respect to its applicability to generate an iris signature from an uncooperative person. More specifically, the present invention enables covert iris signature generation because a person need not totally unobstruct his iris for imaging. Such an aspect of iris recognition is not possible with conventional iris recognition systems.

Returning to FIG. 1, once the preprocessing is complete and the inner and outer boundaries of iris 204 are determined, a mask is generated.

The size of a particular iris taken at different times may be variable in the image as a result of changes in the camera-to-face distance. Further, due to stimulation by light, or for other reasons, the pupil may be constricted or dilated. These factors will change the iris resolution, and the actual distance between the pupil boundary and the limbic boundary.

To solve these problems, the present invention may process the iris image to ensure the accurate location of the two concentric virtual circles defining the iris and to fix the resolution of the radial distance between the two concentric virtual circles. This distance is normalized to be a constant number \tilde{L} pixels for all iris images. \tilde{L} should be decided based on the overall resolution of the iris images in the database. In a working model, the iris images were all of 280-by-320 pixels. The distance from the pupil boundary to the limbic boundary usually fell in the range of 55˜70 pixels. In this case, \tilde{L} should be some value between 50 to 60, because it would be easier to shrink the image size via averaging pixel values than to enlarge the image via interpolating the pixels (which may introduce false patterns). In the working model, \tilde{L}=56.

The iris area is transformed to the resolution invariant polar coordinates. For each pixel in the original iris image located at rectangular coordinates (xᵢ,yᵢ), polar coordinates (rᵢ, θᵢ) are computed as:

$${r}_{i} = \frac{\tilde{L}}{L} ( \sqrt{{( {x}_{i} - {x}_{0} )}^{2} + {( {y}_{i} - {y}_{0} )}^{2}} - {r}_{0} ) , \\ {θ}_{i} = \{ \begin{matrix}arc sin ( \frac{{y}_{i} - {y}_{0}}{{x}_{i} - {x}_{0}} ) & {y}_{i} \geq {y}_{0} \\ π + arc sin ( \frac{{y}_{i} - {y}_{0}}{{x}_{i} - {x}_{0}} ) & {y}_{i} < {y}_{0}\end{matrix} .$$

At the same time, the boundary positions are transferred to the resolution invariant polar coordinates.

FIG. 6(a) illustrates a resolution invariant iris mask for use with the iris image of FIG. 5. In FIG. 6(a), white area 602 represents iris pattern areas, and black areas 604 represent the non-iris pattern areas, such as pupil pixels, eyelids, and eyelashes. FIG. 6(b) shows the iris patterns after applying the mask of FIG. 6(a). Note that the mask is resolution (scale) invariant.

Returning to FIG. 1, after applying the mask to the iris pattern in the invariant resolution polar coordinates, LTP portion 108 generates the local iris patterns, as discussed below.

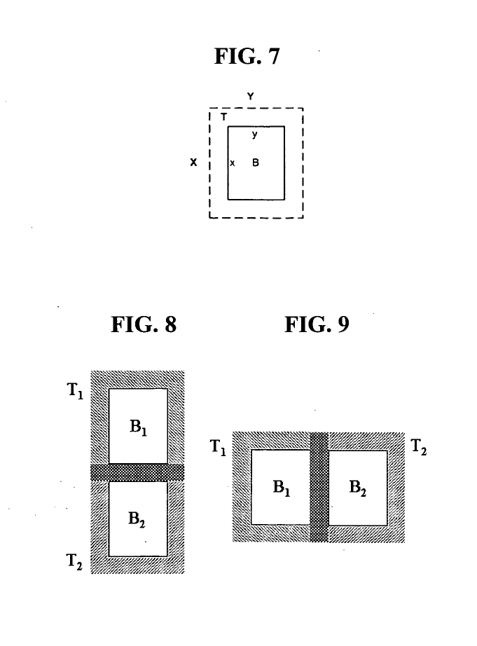

Referring to FIG. 7, let T be a set of pixels in a X-by-Y window of the normalized polar iris image and let B be the center subset of x-by-y pixels in window T, where X>x and Y>y. The mean of the grayscale value of the window T is subtracted from the grayscale values of each pixel in the window B to form the LTP for the pixels of window B.

The LTP of a pixel at coordinate (i,j) inside window B is given as:
LTPᵢⱼ=Iᵢⱼ−m_{T}, 1ᵢⱼεB
where Iᵢⱼ is the grayscale value of the pixel (i,j) in B, m_{T} is the mean grayscale value inside window T.

The reason to select window T to be slightly larger than window B is so that m_{T} can be a better approximation to the true mean grayscale value and is less affected by noise. In computing LTPs, using an overlapping window T can avoid boundary discontinuities. FIGS. 8-9 illustrate exemplary instances of overlapping pixel windows.

In a working example, the size of window T is set to be 15-by-7 pixels and window B to be 9-by-3 pixels. Note that the left-most column of the image in FIG. 6(b) is connected to the right-most column, so there is no real left or right edge that would introduce artifacts. To reduce the effect of non-iris pixels (they appear black in FIG. 6(b)), if more than 50% of pixels in window B or more than 60% of pixels in window T are non-iris patterns, the pixels in window B are discarded as non-iris pattern areas.

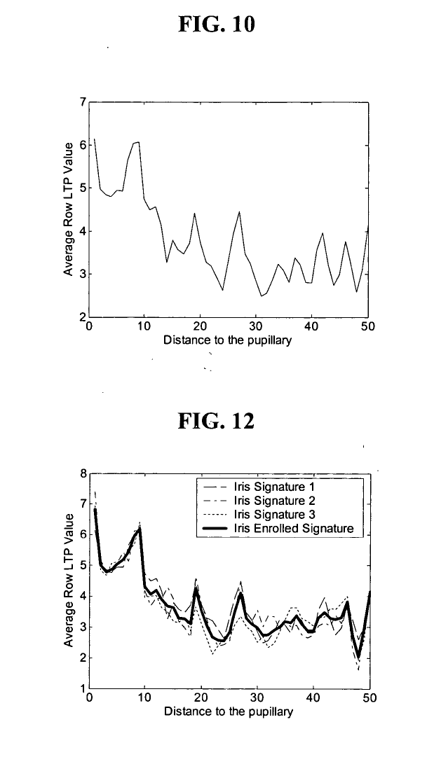

Returning again to FIG. 1, after local iris patterns are calculated by LTP portion 108, iris signature generation portion 110 builds a one-dimensional signature for each iris image by averaging the LTP values of each resolution row of the normalized polar image. If more than a predetermined number, for example 60%, of the pixels in a row are non-iris, the signature value for that row is ignored. The LTP values in the uppermost and lowermost resolution rows of the normalized polar image are usually very noisy as a result of the inclusion of the pupil boundary and the limbic boundary. Accordingly, a predetermined number of these resolution rows, for example 5% of the uppermost and 5% of the lowermost, are discarded when building the iris pattern. FIG. 10 is a graph from the normalized resolution distance from the pupil boundary to the limbic boundary of the iris vs. the average resolution row LTP value, which illustrates the one-dimensional signature for the iris image of FIG. 2.

As illustrated in FIG. 2, typically the iris pixels near the pupil boundary area include more texture pattern variations than other outer circle areas. This is reflected in FIG. 10, wherein the iris signature closer to the pupil has higher average row LTP values. This feature is characterized by relatively high values of LTP along the left side of the plot: these values are the average LTP values of each row in the resolution invariant polar images.

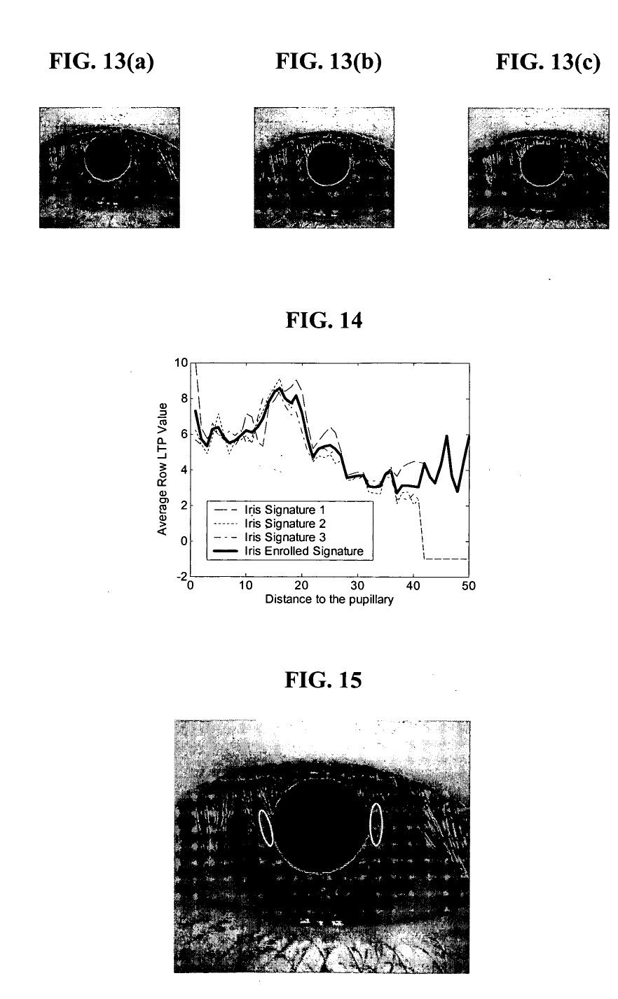

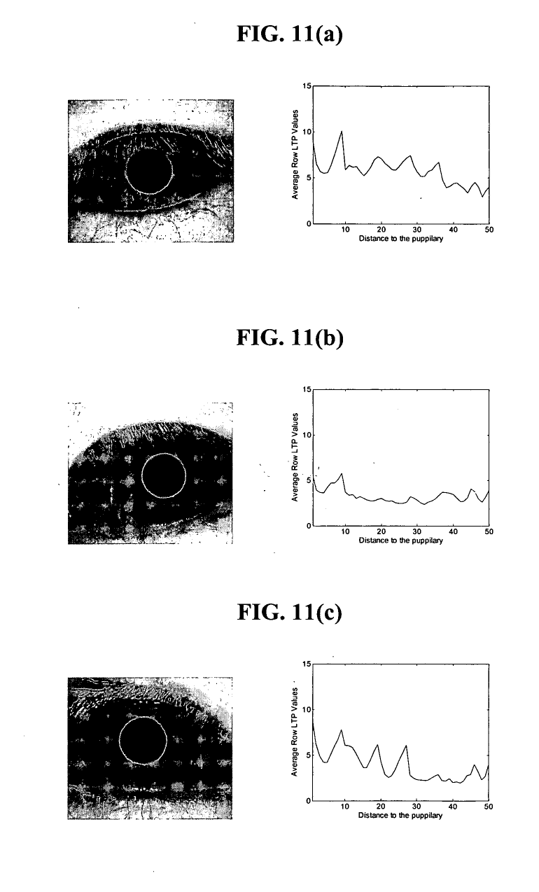

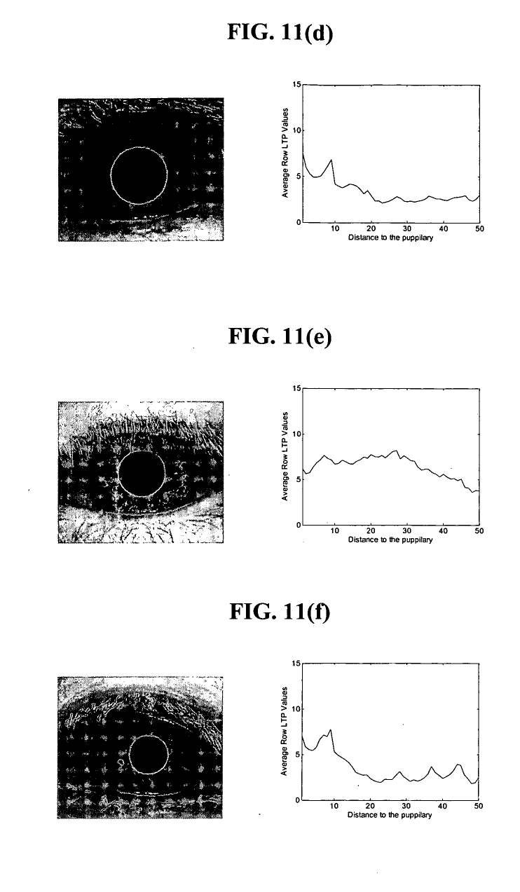

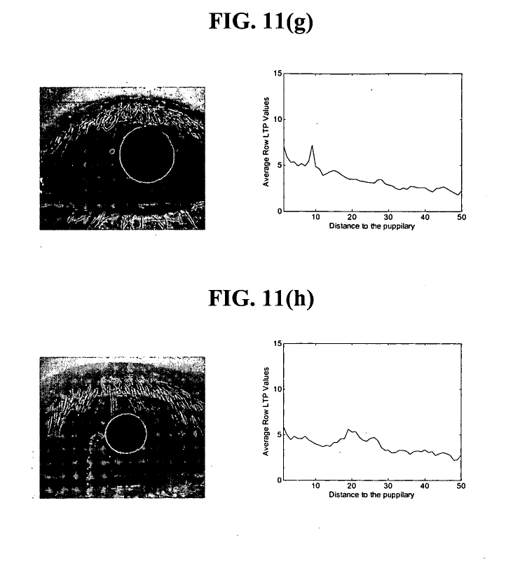

FIGS. 11(a)-11(h) are one-dimensional signatures of eight different irises, and demonstrate that each iris pattern has its own iris signature. Eight signatures are presented along with one of the irises used to calculate it. Comparing the images of the eight irises, the distinct features of individual irises are apparent.

For an iris pattern to be recognizable in the system, the iris pattern should be enrolled into iris signature database portion 116. This process is called enrollment and is performed at enrollment portion 112 of FIG. 1. During enrollment, an iris signature is stored into iris signature database portion 116. However, to reduce the effects of camera angle, glare, etc., when comparing an enrolled iris pattern to a subsequent subject iris pattern, the enrolled iris signature is compiled from a plurality of iris signatures, as discussed in more detail below.

Suppose that Mr. John Doe's iris pattern is to be enrolled in system 100 via a compilation of a plurality of iris signatures. A number X, in this example—three, images of Mr. John Doe's iris are uses as enrollment images. Such enrollment images, as provided by iris image input portion 102, are subsequently sent through preprocessing portion 104, mask generation portion 106, LTP portion 108 and iris signature generation portion 110 to compute corresponding X enrollment iris signatures. The X enrollment iris signatures are then averaged to arrive at the compiled enrollment iris signature, as illustrated in FIG. 12.

Since the iris signatures are not directly related to the angles of the iris patterns, eye rotation would not affect the one-dimensional signal. As such, the iris signature is rotation invariant.

Returning to FIG. 1, when system 100 is used for iris identification, after a subject iris signature is generated by iris signature generation portion 110, the subject iris image signature is compared with the enrolled iris signatures inside the database. A matching score is based on the Du measurement, as discussed below.

A spectral angle mapper (SAM) has been widely used as a spectral similarity measure for multi/hyper-spectral signals. The SAM measures the angle between the spectral vectors

$$r = {( {r}_{1} , {r}_{2} , … , {r}_{L} )}^{T}$$

$$and$$

$$s = {( {s}_{1} , {s}_{2} , … , {s}_{L} )}^{T} , \\ SAM ( r , s ) = {cos}^{- 1} ( \frac{〈 r , s 〉}{‖ r ‖ \times ‖ s ‖} ) .$$

Here, <r,s> is the inner product of vectors r and s, where <r,s>=Σₗ₌₁^{L}rₗsₗ, ∥*| is the vector norm (2-norm), and ∥r∥=\sqrt{r,r>} and ∥s∥=\sqrt{<s,s>}.

Let p=(p₁,p₂, . . . ,p_{L})^{T} and q=(q₁,q₂, . . . ,q_{L})^{T} be the two probability mass functions generated by vectors r and s. The Spectral Information Divergence (SID) between vectors r and s is:
SID(r,s)=D(p∥q)+D(q∥p).

Here D(p∥q) is the relative entropy (also known as Kullback-Leibler information measure) of q with respect to p, where D(p∥q)=L=Σⱼ₌₁^{L}pⱼlog(pⱼ/qⱼ). And D(q∥p) is the relative entropy of p with respect to q, where D(q∥p)=Σⱼ₌₁^{L}qⱼ log(qⱼ/pⱼ). Note that D(p∥q) is usually different from D(q∥p)

The Du measure, also known as (SID,SAM)-mixed measure, is defined as:
Du(r,s)=SID(s,s′)×tan(SAM(s,s′)).

The Du measure takes advantage of the strengths of both SID and SAM, and is used as a key to measure the similarity between two iris signatures.

When system 100 is used for iris identification, a matching score based on the Du measurement is provided for a predetermined number n of the most possible matches from the database. By providing such a prioritized list of possible matches, as opposed to identifying the single match as in conventional iris identification systems, the system of the present invention is much more flexible in implementation.

A test trial of system 100 was conducted using the CASIA iris image database collected by the Institute of Automation, Chinese Academy of Sciences, as described in detail below.

In conventional iris recognition systems, unclear iris images are automatically rejected. Therefore, in conventional iris recognition systems, the eye is required to be open wide and video technology is used to select the best iris images for enrollment. Because the test trial uses the CASIA database, there was no control of the quality of the provided iris images. In any event, the test trial used the iris images as illustrated in FIGS. 13(a)-13(c). This enrolled compiled iris signature is shown in FIG. 14.

The iris images of FIGS. 13(a)-13(c), by conventional standards, are poor. Specifically, the upper eyelids and eyelashes have hidden the upper half and a portion of the lower half iris patterns. In FIGS. 13(a) and 13(c), the reflectance of the lower eyelids has an illumination effect on nearby iris patterns. As a result, the iris patterns in the outer circle have been hidden largely by the eyelids, eyelashes or affected by the abnormal illumination. However, such iris images may be used with the present invention. As illustrated in FIG. 14, for iris signature 2 and 3, the LTP is −1 when the normalized resolution distance from the pupil boundary is larger than 42. This is reasonable because there is less than 40% of valid iris patterns in these iris circles. Therefore, the resulting signature will be same as that of iris signature 1 in these areas. Further, large variances in the iris signature exist near the pupillary areas (normalized resolution distance less than 3), especially for iris signature 1. In FIG. 13(a), it is apparent that the eye is more closed than in the other images. This means that more iris patterns in this area have been hidden by eyelashes or eyelids. If the iris image is enlarged, for example as illustrated in FIG. 15, it is clear that there are some smoother iris pattern areas 1502 that have been hidden or affected by nearby eyelashes. For this reason, areas 1502 are discarded when generating the iris signature for FIG. 13(a), which results in a higher average row LTP values for FIG. 13(a) near the pupillary areas. Overall, the iris images are very similar to each other.

Database portion 116 of the trial test of system 100 contained images of 108 different iris patterns. There were seven iris images for each iris pattern. The first three iris images of each pattern were used to enroll and generate enrollment iris signatures, and 356 iris images were used to test the algorithm. Using match-ranking 1-10 as a measure, all of the iris images correctly fell into the top 10 ranking. Of these, over 97% fell into the top 5 ranking, whereas the lowest rank was 8. The average rank was 1.6.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for identifying a person in a terrorist watchlist, said method comprising:
acquiring data relating to a portion of a person;
processing the acquired data to obtain a one-dimensional signature of the portion;
comparing the one-dimensional signature of the portion with a plurality of one-dimensional signatures; and
outputting a number of the previously stored one-dimensional signatures that most closely resemble the one-dimensional signature of the portion.

2. The method of claim 1, wherein the portion comprises a portion of tissue.

3. The method of claim 1, wherein the portion comprises a portion of an eye.

4. The method of claim 3, wherein the portion of an eye comprises an iris.

5. A system for identifying a feature, said system comprising:
a data acquisition portion operable to acquire data relating to the feature;
a data processing portion operable to process the acquired data to obtain a one-dimensional signature of the feature;
a comparing portion operable to compare the one-dimensional signature of the feature with a plurality of one-dimensional signatures; and
an output portion operable to output a number of the previously stored one-dimensional signatures that most closely resemble the one-dimensional signature of the feature.

6. The system of claim 5,
wherein the feature is a portion of an eye, and
wherein said data acquisition portion comprises a camera operable to obtain an image of the portion of the eye.

7. The system of claim 6, further comprising:
a preprocessing portion operable to isolate a portion of the image of the iris of the portion of the eye from the image of the portion of the eye,
wherein the acquired data comprises data corresponding to the portion of the image of the iris.

8. The system of claim 7, wherein the acquired data comprises data selected from the group consisting of color data, patterning data, size data, shape data, nuclear resonance data, electromagnetic reflectivity data and electromagnetic absorption data of the portion of the image of the iris.

9. The system of claim 6, further comprising:
a preprocessing portion operable to isolate a portion of the image of the retina of the portion of the eye from the image of the portion of the eye,
wherein the acquired data comprises data corresponding to the portion of the image of the retina.

10. The system of claim 9, wherein the acquired data comprises data selected from the group consisting of color data, patterning data, size data and shape data of the portion of the image of the retina.

11. A data processing device comprising:
a signature generator operable to convert a plurality of two-dimensional polar coordinate image data into a plurality of one-dimensional signatures of the image data, respectively,
wherein said signature generator is further operable, to generate a final one-dimensional signature based on the plurality of one-dimensional signatures.

12. The data processing device of claim 11, wherein said signature generator is operable to generate a final one-dimensional signature based on an average of the plurality of one-dimensional signatures.

13. The data processing device of claim 11, wherein said signature generator is operable to convert each of the two-dimensional polar coordinate image data into a corresponding one-dimensional signature of the image data based on mean gray scale values of groups of image pixels within areas of the two-dimensional polar coordinate image data.

14. A data processing device comprising:
a subject receiving portion operable to receive a one-dimensional subject signature corresponding to two-dimensional data of a subject;
a comparing portion operable to compare the one-dimensional subject signature with a plurality of one-dimensional signatures; and
an output portion operable to output a number of the plurality of one-dimensional signatures that most closely resemble the one-dimensional subject signature.

15. A method of identifying a feature, said method comprising:
acquiring data relating to the feature;
processing the acquired data to obtain a one-dimensional signature of the feature;
comparing the one-dimensional signature of the feature with a plurality of one-dimensional signatures; and
outputting a number of the previously stored one-dimensional signatures that most closely resemble the one-dimensional signature of the feature.

16. The method of claim 15,
wherein the feature is a portion of an eye, and
wherein said acquiring comprises obtaining an image of the portion of the eye via a camera.

17. The method of claim 16, further comprising:
isolating a portion of the image of the iris of the portion of the eye from the image of the portion of the eye,
wherein the acquired data comprises data corresponding to the portion of the image of the iris.

18. The method of claim 17, wherein the acquired data comprises data selected from the group consisting of color data, patterning data, size data, shape data, nuclear resonance data, electromagnetic reflectivity data and electromagnetic absorption data of the portion of the image of the iris.

19. The method of claim 16, further comprising:
isolating a portion of the image of the retina of the portion of the eye from the image of the portion of the eye,
wherein the acquired data comprises data corresponding to the portion of the image of the retina.

20. The method of claim 19, wherein the acquired data comprises data selected from the group consisting of color data, patterning data, size data and shape data of the portion of the image of the retina.
